(19) United States
(12) Patent Application Publication
(10) Pub. No.: US 2010/0185461 A1
(43) Pub. Date: Jul. 22, 2010

(54) METHOD FOR CONTROLLING THE PURCHASE OF HEALTH CARE PRODUCTS AND SERVICES

(76) Inventors: H. Douglas Broeska, Winnipeg (CA); Remo J. Aiello, Winnipeg (CA); Steven Benoit, Laporte, CO (US)

Correspondence Address: ADE & COMPANY INC., 2157 Henderson Highway, WINNIPEG, MB, R2G1P9, CA

(21) Appl. No.: 12/357,897

(22) Filed: Jan. 22, 2009

(51) Int. Cl. G06Q 50/00; G06K 5/00

(52) U.S. Cl. 705/3; 705/2; 235/380

(57) ABSTRACT

A method comprising the steps of: receiving at a host computer a request from a provider for a payment for a charge incurred by a purchaser and withdrawing from a designated account, all or a portion of the cost of the item based on the payment authorization.

This invention relates to a method for controlling the purchase of health care products and services. More particularly the invention relates to a method of administration of healthcare information storage and payment options through the use of a smartcard linked to an open and independent Internet-based operating system. This system can be used by any hospital system, insurance provider or personal health record system (PHR) if those users have a need to link patient records or any other relevant data with financial data.

### BACKGROUND OF THE INVENTION

U.S. Pat. No. 7,434,729 (Cracchiolo) assigned to American Express and issued Oct. 14, 2008 discloses an arrangement by which a financial institution manages requests for payment of health care services using a credit card by separating the total price into parts which are covered by a payment plan and parts which are not and by extracting payment from different accounts accordingly. The system is owned and managed by the financial institution which supplies the cards, manages the transactions and holds the funds. While described as a “closed loop”, it is an exclusionary closed loop and does not allow for open management, or any other management of accounts, payments or payment instruments, including cards other than those deemed appropriate through the rules of the financial institution. While many various embodiments of the Cracchiolo invention are described in their patent, it is understood that they all relate to these financial institutional control features and are limited in all respects to that definition.

The concept known as 2.0 Health represents the consumer-centric transformation of the US healthcare system. 2.0 Health is characterized by the ability to rapidly share, classify, summarize and distribute individual health information with the goals of improving healthcare systems and thus the experience and outcomes for patients and stakeholders. We believe that the addition of the arrangement described hereinafter to the system concept greatly enhances the ability of the model and provides an almost limitless potential in providing benefits to the general public.

While the tools and techniques to create the new health paradigm are still being defined, it is clear that static online systems known as personal health record systems or PHRs are limited in their ability to fully optimize the use of available technologies. By incorporating the technology herein described into a PHR platform to extend its use, the consumer-based movement in healthcare might take a quantum leap forward.

Presently the US healthcare system, the most complicated in terms of delivery and payment in any developed country, results in consumers paying healthcare providers $250 billion and insurance companies paying providers $1.3 trillion annually. This system spends 15 percent of each health care dollar on payment mechanics. In contrast, the retail industry spends 2 percent.

This climate offers a tremendous opportunity beyond the sharing and exchange of information, through forging a link between the delivery of health care services and the adjudication and settlement of financial records.

Current processing of transactions in the health care system is clearly inefficient and needs reengineering. Major US corporations are investing heavily in personal health record systems (PHR) and electronic health record systems (EHR) but the two are't yet linked. Definition of standards is illusive; system constituents are varied and splintered in dialogue and intent.

Validated by what they feel will be consumer-driven market demand, many healthcare operatives have raced to launch online personal health record programs (PHR) basing their models on non-financial motivators. PHR systems are designed to enable patients and physicians to exchange essential health information, thus empowering both the patient and doctor with the tools to make better choices regarding patient health. PHR program format allows users to collect, store and share health information with family members and offers a choice of third-party applications and devices to help them manage other health factors such as fitness and diet.

A primary weakness of PHR systems is, however, while they allow the aggregation of patient information, they do not support a common information format (Continuity of Care Document) that would communicate with hospital or clinic information systems. Without a standardized information format, providers may not trust or use the data as it may be professionally unsuitable and legally risky. Despite the lack of current connectivity, exchangeability, and information flow, the highest value of PHRs is seen as their future interoperability which could create a savings to the system of $19 billion annually. Most new development is attending to this area of weakness with the belief that once standards are in place, alignment between systems and economies of scale will follow.

Economic reasons to use PHRs may suggest a more compelling model and various methods of linking payments to health information exist. While payment options aren't considered in any analyses of PHR systems, low adoption rates for the current systems should demand that alternative implementation models be considered.

Linking payer contracts to payment platforms through a PHR system creates an economic package beneficial to all stakeholders. Smart health cards as an information platform have been universally adopted in most other countries around the world. Smart cards link the patient's PHR to the health system's EHR with pocket portability in a format that provides security and authentication.

As a payment method, although only 20% of consumer healthcare is currently paid for through “plastic” card sources, this number is expected to grow to 30% by 2010. Some US companies offer this alternative format for payment, but cannot link the PHR. For example, the smart debit card associated with Consumer Directed Healthcare Plans (CDHPs) is a start but does not provide “closed loop” authentication, nor does it carry any patient/provider/payer information, or the ability to access healthcare services outside of a designated provider.

PHRs are in the early phase of their use as a universal public healthcare utility but the value proposition for the format is still unclear. Several years after a strong launch by leading companies including Microsoft and Google, the initial excitement about PHR has yet to translate into solid evidence that there is a widespread need. Consumer adoption rates have been low despite the size of the investment by many companies. Although 70% of Americans have access to PHRs, only about 2% are using them.

Given the system-wide commitment to PHR use and the focus that entire healthcare systems and organizations are putting on their universal implementation, there needs to be clear motivators that will recover the value potentials of PHR systems. Static information storage and retrieval functions are not inducement enough to build interest. Many PHR companies are adding on commercial features in the hope that something will “catch on”, but these innovations are after the fact. The original intent upon which PHR was founded needs to be reworked to offer healthcare solutions that will drive consumer usage higher. This new invention can be added to enhance PHR and provide a far more compelling value proposition for consumers.

### SUMMARY OF THE INVENTION

It is one object of the invention to provide a method for controlling the purchase of health care products and services.

According to one aspect of the invention there is provided a method for controlling the purchase of health care products and services comprising:

providing an automated clearing house (ACH) managed by an independent card-clearing service organization (ISO) or processing center for managing communications of financial and medical data;

providing a holder of funds for payment for the health care products and services;

supplying to each of a plurality of users a card having card data thereon;

defining for the users a plurality of authorized merchants of health care products and services;

selling to each of a plurality of subscribers, a health care system in which a plurality of users associated with the subscriber are provided with funds to pay for health care products and services from the plurality of authorized merchants;

each of the subscribers being arranged to place a selected amount of funds for each user associated with the subscriber in an account associated with the user held by the cardholder;

providing to each of the authorized merchants a conventional merchant terminal for payment of funds by card;

providing to each of the authorized merchants a method by which their merchant number will be communicated to the ISO for payment of funds by a card;

providing a series of codes each identifying one of the health care products and services to be supplied by the plurality of authorized merchants;

in each purchase transaction, on presentation of the card by a user to pay a price for one of the health care products and services, causing the merchant terminal to communicate data to the ISO containing the price, some or all of the card data, the merchant number and the code to the ISO;

the ISO being arranged for each purchase transaction to obtain data from the holder of funds as to the availability of the necessary funds in the account of the user and to authorize payment of the price to the merchant in the event that the merchant number is authorized and the funds are sufficient to pay the price;

providing linkage to a Patient Heath Record (PHR) system for storing for each user the codes of health care products and services purchased by the user in association with the user;

and, for each purchase transaction of health care products and services purchased by the users, separating the code and storing the code in association with the user at the PHR.

The arrangement herein provides therefore a computer based method to facilitate purchases of a plurality of healthcare products and services, utilizing a payment card or other transactional device or method issued by an independent card-clearing organization (ISO) that accesses a special spending account via existing merchant terminals and Internet payment methodology.

The payment transaction also associates the provider's medical information to the payer using a universal coding method, such as the ICD-9 code and the standard POS merchant terminals transmit the data.

No special or additional equipment is required but only authorized merchant terminals registered to the system can be used to make payments. Merchants/providers become authorized through a registration process which includes supplying their merchant number associated with their terminal. The entry of a merchant number into the system links that merchant to the automated clearing house network in a closed loop.

The Automated Clearing House (ISO) is certified to carry out transactions worldwide. Transactional steps are comprised of: authorizing a the provider's point-of-sale merchant terminal, offering payment for services at a registered provider with a proprietary payment card, accessing funds deposited to a subscriber's spending account from either that registered merchant terminal or alternatively, a computer-based Internet website hosted for the single purpose, causing the subscriber's health spending account to be debited for amount of the item. The subscriber's spending account is funded through the dedicated e-commerce site that allows for money transfers to be made through the Internet from a plurality of sources.

Aside from the financial data that will be collected for payment of medical services, each transaction for purchase of a good or service will be associated to the universal accepted medical code known as the Current Procedural Terminology or CPT code or another such code consistent with an individual sponsor's medical terminology system. Transmitting this coded information directly into the sponsor's practice management system or other authorized systems as may be necessary to fulfill the transaction, will assist the provider to verify the claim through electronic submission. The successful completion of financial transaction will cause the creation of a separate medical record that will be automatically generated and securely stored for retrieval in any authorized sponsor's electronic medical record system. This information may then be further made available to third-party, stand-alone patient health record systems or PHRs or alternatively, form the basis of an electronic medical record system (EMR). Standardized forms of both financial and medical data will create a record that may be used by multiple authorized third parties including insurance companies, healthcare systems, hospital systems, clinics, or PHR hosts. Standardized generation of data with the authorization of the subscriber creates a comprehensive and reliable patient medical history more appropriate for use by physicians than current data collection methodologies.

The card can be used also to securely house scripts issued by doctors (and with the number of refills allowed/remaining), to be filled by participating pharmacies. This leverages not only the payment and medical record tracking aspects of the invention, but adds a fraud-prevention aspect in reducing forged prescriptions. In particular, scripts for substances like morphine and medical marijuana are frequent forgery targets, and having records of scripts would discourage dishonest doctors from writing scripts without medical justification.

The arrangement described herein is unique in that:

1) There is no other technology that can turn any existing merchant terminal into a terminal that communicates with our automated clearing house in a closed loop. This means that unrelated providers can be affiliated to our service through their existing merchant terminal.

2) The card is proprietary to the sponsor and does not have to be issued by a financial institution.

3) There is no system or business method that has proposed associating the financial transaction data with a medical procedure code (ICD-9 or CPT codes), segregating that information thus creating a separate patient medical information file based on that data.

The arrangement described herein offers to link the PHR, the EMR, the payer contract, the provider identification, and the list of every vendor in every business authorized to act on a patient's behalf as well as the payment platform.

This arrangement described herein offers a solution that would greatly enhance current PHR systems beyond their function as a simple data repository. By integrating smart pay card service options directly with health data input, any PHR system could expand the use of its program into many other areas of healthcare and serve a far greater number of patients with a far greater purpose than their current model supports, while maintaining higher levels of security on all information.

Advantages of an interoperable system monetized by the arrangement described herein are:

a) Making use of Open ID credential authentication, the technology can actively link all patient record keeping systems to invoices for services. Reporting and recording occurs in real time to the payer, the provider, and the consumer's “account.”

b) The PHR system becomes a more effective healthcare platform when the PHR's patient health records are linked to records of payment, and the PHR system also becomes monetized.

c) Payments can occur with the simple insertion or swipe of a card through any provider's authorized merchant terminal or online as required using current technology.

d) The records of payment from use of the card for health services provide standardized structure and organization to a patient database that is presently created from multiple disconnected entry points, with quite a lot of random and subjective patient data.

e) Improved accuracy and information quality improves the safety of the PHR system and supports the efforts of doctors, pharmacists and other healthcare providers in their mandates to ensure best-practice decision outcomes.

f) Standardized financial and medical information through the PHR operating system provides interoperability between provider-tethered, payer-tethered and third-party PHRs through easy data exchange.

g) In addition to patient health records, a PHR or its sponsoring clients can replace financial institutions as the issuer of health spending accounts by virtue of the processing capabilities of this new technology. The invention provides a payment platform independent of closed loop card networks proposed by financial institutions.

h) A PHR's broader affiliations will provide an access point from which to offer uninsured consumers various levels of healthcare coverage through aggregation.

j) For any healthcare provider considering integration with a PHR, the reduction in outstanding accounts receivables would be a definite enticement.

k) For any insurance payer considering integration with a PHR, the reduction in administrative expenses would be a definite enticement.

l) State, government and private agencies could fund health spending accounts through social programs where the value is directed toward specific services for the cardholder and where that value recovery would not be subject to misuse or abuse.

m) Any PHR so linked can develop a Patient Safety Program so that all emergency services and events will be satisfied because patient-critical information can be tied to PIN identification.

n) An integrated card platform would attract consumers, providers, and payers. This integrated design allows enhanced economic opportunities while supporting socially responsible and affordable healthcare goals in an expanded model.

The card system can be accepted though either a closed-loop secure web-based payment portal or physical electronic terminal that has been linked to the network. The card system described herein is not only a payment method that links to the cardholder's Health spending account (HSA) but also works as an access card for discounts and ultimately as a tracking method for the card “spend” and access to personal health records. Although this description refers to an HSA, any type of account, such as an FSA, or HRA may be used for the purpose of linking to the card. The closed-loop system limits the monetary spend on the card to specific health-based services or health-based retailer, or any providers so linked to the card network system.

The card system has the ability to interface with the merchants' payment system allowing the merchant to continue to accept major credit cards Visa, MasterCard, and American Express as well Debit on the same physical electronic terminal. The client's/merchant's terminal will communicate directly to the card back-end when the card is presented for payment and will authorize customers' credit and debit transactions.

The card system also can be utilized through a cost-effective browser-based interface on any compatible computer as a secure web-based payment portal also accepting all major credit cards. The web-based browser system employs secure data encryption technology—128-bit Secure Socket Layer (SSL), industry proven encryption standards and security protocols to safeguard customer information. The encrypted system allows for transmission of medical CPT or ICD-9 codes along with the payment linking both transaction and making them available in the reporting function. It will be apparent to a person skilled in the relevant arts that this invention can be so employed in this application and is not limited to the field of healthcare.

With the Online reporting option the card system offers data retrieval and management information reporting on a 24 hour per day basis. With online access to real-time transaction data interested and authorized parties can obtain critical, current and historical information at the merchant or healthcare providers' convenience. A dynamic search engine reviews individual transactions or a set of transactions.

In the money flow, the card is loaded by either the subscriber or employer or the cardholder at either the authorized health care provider, retailer or through the card system secure website using a major bankcard (Visa, MasterCard, American Express or authorized bank transfers (ACH). The funds are held in a trust account or a transaction account for distribution to the appropriate authorized health care provider or professional as well as to any authorized retailer or service provider deemed active by the card system described herein.

The card system is arranged to allow healthcare providers, healthcare insurers, and other third-party administrators and/or card sponsors to use the card system in a manner in which they see fit and in a way that allows them to manage their own system. While specific configurations and embodiments of the invention are discussed for illustrative purposes, it is understood that these are presented by way of example and not limitation; one user's needs regarding the function of card system may be different than another user's needs. It will be apparent to a person skilled in the pertinent art that this card system can be applied in one of many ways or employed in a number of different applications.

For example, the card may be used as a pay card alone without the need to carry medical information regarding the transaction event.

Similarly, a third-party administrator (TPA) may wish to link a plurality of funded accounts to be able to:

a) fund any particular card transaction and arrange those accounts to comply with their client's company policy,

b) allow adjudication procedures where extended settlement times and holds on payments may be appropriate,

c) configure the system to account for tax rules to benefit the client,

d) allow access to investment accounts which may be included as a constituent of the transaction,

e) configure payment flows which are different for some accounts than for others,

f) allow the authorization of healthcare providers for some accounts that are different than for others,

g) allow various other authorizations and notifications that are different for some accounts than for others,

h) allow transaction fees that may be added or that are different, arrange for discounts that may be added or that are different,

j) allow funds from certain accounts which may be uniquely accessible for use at some providers and not others, or

k) create any other configuration of usage based on the determination and undertaking of the TPA using the flexible options of the invention.

Additional features can be added or deleted as needed.

The flexibility of the card system allows for multiple options regarding merchant providers, payments, claims, authorization and access, adjudication, reporting, report generation, and communication modes.

The card system is arranged to allow third-parties to be able to issue smart health cards that they could also use as payment platforms, link the medical and payment events together in real time to provide professionally generated credible medical and financial information for use by interested parties. This occurrence will authenticate users, eliminate complex, lengthy and expensive administrative procedures, accelerate cash flow for healthcare providers, eliminate the need for patients to pay out-of-pocket costs, create discounted payment schedules based on the elimination of provider costs including the cost of paying by credit card, and allow the TPA to manage their own system as they see fit for better control of their individual healthcare programs.

This card system can be used to enhance any personal health record (PHR) platform as the payment system can be linked directly to the medical information and applied to the card dynamically and in real time. The card system is arranged to allow interoperability with other systems, a stated goal of the US Administration for PHR. There is no other system that currently allows this possibility and in that respect the card system is unique and while many various embodiments of closed loop health card systems are claimed by others in the regards stated above, none allow the TPA to openly use, manage, interoperate, and cooperate with other stakeholders.

### BRIEF DESCRIPTION OF THE DRAWINGS

One embodiment of the invention will now be described in conjunction with the accompanying drawings in which:

FIG. 1 is a schematic layout of the components of the system according to the present invention.

FIG. 2 is a schematic illustration of the card processing protocol.

FIG. 3 is a schematic illustration of the medical data processing protocol.

In the drawings like characters of reference indicate corresponding parts in the different figures.

### DETAILED DESCRIPTION

Attention is directed to the above U.S. Pat. No. 7,434,729 (Cracchiolo) assigned to American Express which discloses many details of the arrangement of the present invention, the disclosure of which is incorporated herein by reference.

The following terms are used in this document and for convenience are defined as follows:

The term “merchant” as used herein shall mean any person, entity, distributor system, software, and/or hardware that is a provider, broker, and/or any other entity in the distribution chain of goods or services. For example, a merchant may be a credit card issuer, a hotel chain, an airline, a grocery store, a retail store, a travel agency, a service provider, including, but not limited to, a medical service provider, an online merchant, or the like.

As used herein, an “item” may be one or more of information, good and/or service capable of being exchanged between entities. In addition, an “item identifier” may include, for example, one or more of a universal product code (UPC), a stock keeping unit (SKU), a serial number, a reference number, a category number, a service type indicator, a requestor name, a price, a description and/or any other information capable of identifying an item.

A “transaction account” as used herein refers to an account associated with a closed account card or a closed account card system (as described below). The transaction account exists for the purpose of funding the item transaction.

“Open cards” are financial transaction cards that are generally accepted at different merchants. Examples of open cards include the American Express, Visa, MasterCard. and Discover cards, which may be used at many different retailers and other businesses.

“Closed cards” or proprietary cards are financial transaction cards that may be restricted for use with a particular merchant, a particular chain of merchants or a collection of affiliated merchants. In the case of The CARD described herein, this loop can be expanded by creating “hybrid” cards that may be linked to retailers that do not compete or have affiliations with each other.

The term “transaction instrument” as used herein may include any type of open or closed charge card, credit card, debit card, FSA card, stored value card, an RFID chip based card or token, and the like. For convenience, a transaction instrument may be referred to as a “card.”

An “account,” “account number” or “account code”, as used herein may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder, radio frequency card or payment statement).

A FSA is an account set up to hold the withheld portions, and to pay for certain categories of items that qualify for pre-tax treatment under the Internal Revenue Service Guidelines. As it currently stands, if an employee wishes to, for example, establish both a FSA for qualifying childcare expenses and a FSA for qualifying medical expenses, the employee must establish two FSAs and designate how much of the employee payroll to withhold and credit to each FSA. The employee may then withdraw the funds held in each FSA as the employee purchases qualifying items associated with each respective FSA.

Currently, to withdraw funds held in a FSA for qualifying expenses, the employee typically must first purchase the qualifying item, then request the FSA administrator to reimburse the employee for the purchase. More specifically, the employee is usually required to pay for the item at the point of sale, complete and file a claim form along with the sales receipt, wait for the FSA administrator to process and approve the claim, and wait to receive reimbursement. Thus, the current process for withdrawing FSA funds for qualifying expenses is time consuming, requires the employee to be “out of pocket” until reimbursement arrives, and necessitates that the employee perform various tasks after the purchase. Furthermore, in situations where the employee incurs a claim for expenses in different types of FSAs (e.g., a medical expense FSA and a childcare FSA), the employee is generally required to file two claims, one for each respective FSA, following the above steps.

In a typical FSA, which is the most established of the CDHPs, an employer deducts pre-tax dollars from an employee's pay check to cover IRS-approved healthcare expenses, and the deducted amount is put in the employee's FSA. The employee pays for healthcare goods and/or healthcare services (“goods/services”) out of pocket, and submits a receipt for the goods/services for substantiation and reimbursement. A third party administrator (“TPA”) reviews the receipt and confirms the purchase of the goods/services. Once confirmed, the TPA sends a reimbursement check to the employee and the TPA is reimbursed by the employer. Funds in the FSA that are not used by the employee by the end of the year are forfeited to the employer. TPAs have begun to offer debit cards to employees for payment of healthcare goods/services. These debit cards enable automation of some aspects of claims substantiation.

A Health Spending Account or HSA works in conjunction with an insurer's health insurance plan, which incorporates employee-paid deductibles. An employer and/or an employee contributes pre-tax dollars to the employee's HSA to cover IRS-approved healthcare expenses. The contributions are allowed to roll over from year to year and to accumulate tax free indefinitely. Funds in the HSA may be transferred from an investment account to a cash account to pay for expenses. When an HSA card or an HSA check is given to a provider for payment of healthcare goods/services, the provider submits a claim to the insurer. The insurer then determines the employee's share of the payment, withdraws the determined amount from the employee's cash account, and records that amount as part of the employee's deductible. For the purposes of this invention the HSA refers not only to the above arrangement, but may also refer to the account set up for the purpose of holding funds associated with the subscriber for the purpose of the healthcare spend.

As used herein, “point of sale device” or POS may be any software and/or hardware suitably configured to facilitate a purchase. It may include any means or manner of communicating with one or more host computers for the purpose of making requests for payment or payment authorization. Such means may include, but are not limited to, telephonic means, card readers, computer terminals connected directly to the host computer(s) or indirectly, via e.g., the Internet, or any other means of communication known to persons skilled in the relevant arts.

Additionally, as used herein, “data” may include encompassing information such as commands, queries, files, data for storage, and the like in digital or any other form.

“Transaction data” may include, for example, one or more of the amount of purchase, at least one payment instrument account number, at least one payment account number, at least one item identifier for each item being purchased, loyalty information, demographic information and/or any other data helpful in processing a transaction.

“Medical Codes” are intended to convey essential information quickly and with a minimum of misunderstanding to physicians, healthcare providers, insurance companies and other stakeholders. For example, ICD medical codes are used worldwide for to convey procedures, statistics, reimbursement information and automated decision support in medicine. This system is designed to promote international comparability and interoperability with other systems so configured in the collection, processing, classification, storage and presentation of this information.

An ISO is an Independent Sales Organization that represents a Bank or Bank/Processor alliance. The ISO has an agreement to sell the services of the Bank or Bank/Processor alliance, and is allowed to mark up the fees and sign up merchants. These entities perform a middle function as they typically match the banking services they sell with “front end” solutions for accepting transactions in order to offer merchants a working system. Their Front End Systems can be anything from POS Terminals to PC-based Credit Card Processing Software, paired with a Secure Payment Gateway. In all cases, the Front End solution must be compatible with the Processor in order to function.

The Back-End Network is the platform that takes captured transactions from the Front-End Network and settles them through the Interchange system. The back-end generates daily Automated Clearing House or ACH files for merchant settlement. Other functions typically handed on the back-end include chargeback handling, retrieval request and monthly statements. In the case of The CARD described herein, the ISO is also the back-end processor.

Persons skilled in the relevant arts will understand the breadth of the terms used herein and that the exemplary descriptions provided are not intended to be limiting of the generally understood meanings attributed to the foregoing terms.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments whether or not explicitly described.

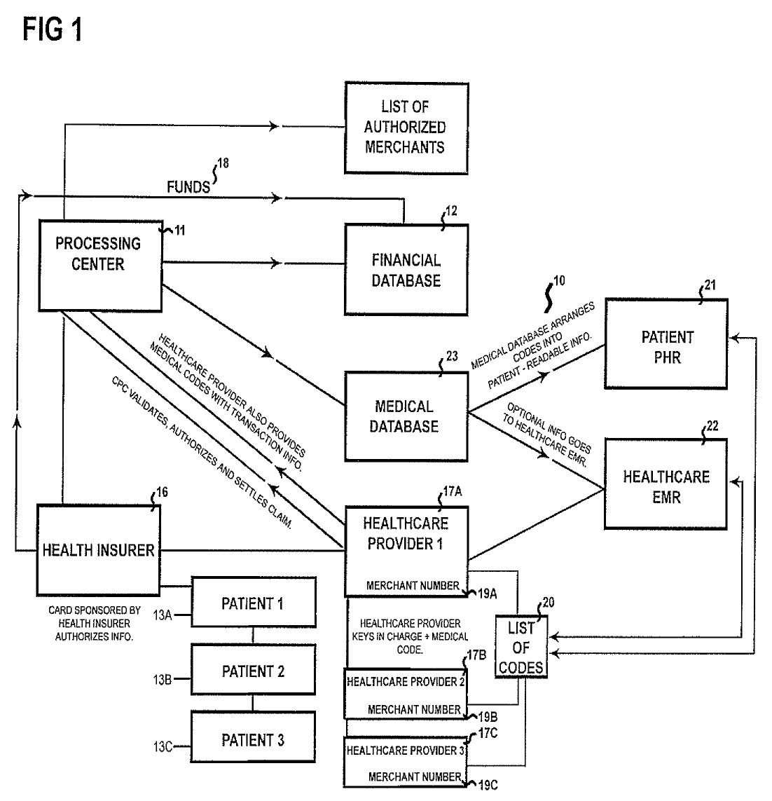

One arrangement according to the present invention is shown in FIG. 1 which shows a method or system for controlling the purchase of health care products and services generally indicated at 10. The system includes a processing center 11 for managing communications of financial and medical data. A holder of funds for payment for the health care products and services is indicated at 12 and comprises a financial data base for receiving and holding funds.;

The system is used by a plurality of users or patients indicated at 13A, 13B, 13C etc each being supplied with an individual card 14A etc having card data 15 thereon.

The health insurer 16 defines and communicates with a plurality of authorized merchants 17A, 17B, 17C etc of health care products and services, each of which is authorized to provide acceptable services in the health field.

The system is used by a plurality of individual subscribers each of which has a plurality of the users or patients associated with the subscriber. Each patient of each subscriber is provided with funds 18 supplied by the health insurer to the financial data base pay for health care products and services from the plurality of authorized merchants to the patients. The funds are requested from the subscribers to the health care provider in an amount dependent on the plan to be provided by the subscriber to the patients associated with that subscriber. Typically the subscriber is an employer and the patients are employees and the program may vary for different categories of employee/patient. Thus each of the subscribers is arranged to place a selected amount of funds for each user/patient associated with the subscriber into an account associated with the user/patient held by the holder 12.

Each of the authorized merchants 17A etc is given a conventional merchant terminal for payment of funds by credit card. Each of the authorized merchants is given a merchant number 19A, 19B, 19C etc arranged to be communicated to the center 11 for payment of funds by credit card.

A series of codes 20 is established for the system which identifies each of the health care products and services to be supplied by the plurality of authorized merchants 17A etc. The system further includes a patent PHR 21, a healthcare EMR 22 and a medical data base 23.

In operation of the system, the individual patients can select at their own choosing healthcare providers from the authorized list 17A etc and contracts with that supplier to receive a particular medical procedure or product solely depending on their own perception of their needs. Each purchase transaction is effected on presentation of the card by a patient/user to pay a price for one of the health care products and services. The merchant terminal is thus arranged to communicate data to the processing center containing the price, the card data, the merchant number and the code. The processing center 11 is arranged for each purchase transaction to obtain data from the holder of funds that is the financial data base 12 as to the availability of the necessary funds in the account of the patient/user and to authorize payment of the price to the merchant in the event that the merchant number is authorized and the funds are sufficient to pay the price.

Data is communicated from the processing center 11 to the Patient Heath Record (PHR) system for storing for each user the codes of health care products and services purchased by the user in association with the user.

On each purchase transaction of health care products and services purchased by the users, the codes are separated, stored and distributed and transaction information is available at the PHR to those authorized and interested parties in addition to, or in association with the user.

In all purchase transactions all codes are approved without analysis and the price is paid in all cases provided the funds are available to cover the price.

In all purchase transactions all authorized merchants are approved without analysis.

The codes are not stored by the processing center 11 to avoid breach or privacy.

The PHR is accessible by the user separately from the transactions above to add user information provided by the user in addition to the codes.

The merchants may be required by the authorizing authority such as the Health Insurer 16 to provide a discount on the price in order to be authorized.

The system may be initiated and sold to the subscribers by primary health care providers. In order to provide an incentive for the provider 17A etc to effect sales, each card can be sold to a subscriber for a set price which is added to the amount to be applied to the users account with the profit going to the party selling the system.

The funds are held securely in trust on behalf of the owner in a financial institution in compliance with all Payment Card Industry Data Security Standards as well as all laws and regulations directed at consumer protection for the electronic transfer of funds which provide strict error resolution procedures.

While one PHR is shown, typically there is a plurality of PHRs and wherein the system selects that one which is associated with the user.

The system is arranged to support a plurality of separate cards where each card is a proprietary card supplied by one party and is associated with a plurality of authorized merchants selected by that party.

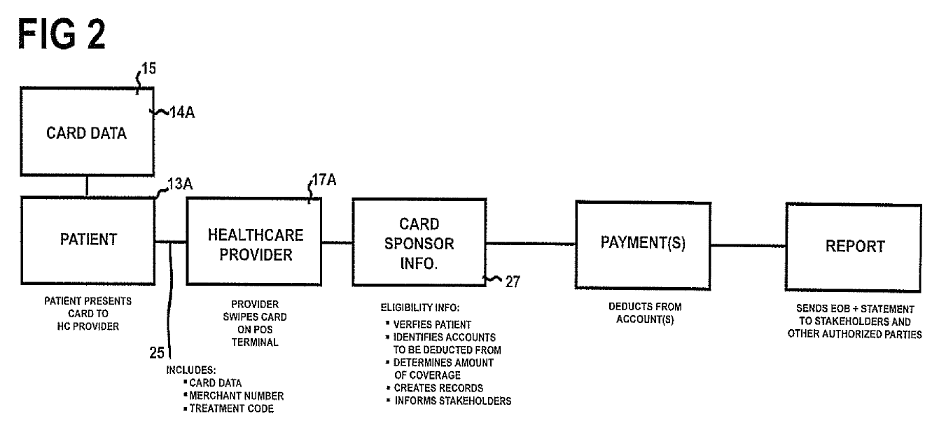

Thus in the arrangement a card sponsor which can be the Health Insurer, Clinic, Hospital System, etc, provides for each patient access a Health Spending Account (HSA) or some other type of account used for the purpose of funding the card. In a simple illustration of the modular process shown in FIG. 2, the cardholder or patient 13A presents the sponsored card 14A to the Healthcare Provider 17A as shown at step 25. The Provider swipes the card on the merchant POS terminal and the card sponsor information verifies the cardholder's identity, identifies the account or accounts from which payment shall be deducted, determines the amount of coverage to be extended upon the presentation of the card for the purpose, creates the data for a record of the transaction which may or may not include medical information through the addition of medical codes as shown at step 27. Upon determination of eligibility, the system authorizes payment and deducts money from the HSA and/or other accounts associated with the card sponsor's pre-determined payment policies. In the final instance a record of all transactions medical and financial is created for the stakeholders and segmented for those who are authorized to view and use the data.

The schematic of FIG. 1 represents an embodiment of the invention implementing the closed loop network in the healthcare setting. This example follows the transfer of payment and medical information in the process. As the card is swiped or inserted into the POS device at the Healthcare Provider, the metrics are transmitted to Processing Center 11 after validations and claim information has been delivered to the Health Insurer for authorization. Charges may be based on retail costs, discounted retail costs, or based on the card member's plan data as supplied by the Health Insurer 16 to the Card Processing Center (CPC) 11. All other procedures based on the card sponsor's policies and procedures can be programmed into the system for the CPC to interpret and transmit. For example, holds may be put on payments until rates can be negotiated with the Health Insurer 16, thus delaying settlement until adjudication. Once authorization codes have been matched, the CPC 11 then sends the transaction information to the financial database 12 and the medical codes to the medical database 23 for storage and distribution to the PHR 21 and the EMR 22.

The medical codes are interpreted electronically and re-cast in readable terms and standardized format and sent to the patient's PHR where they are available to authorized access via the Internet. The same information can optionally be sent to the Healthcare Provider's Electronic Medical Records system (EMR) to supply or augment the medical data in the EMR.

This configuration of the system allows for all information transfer and payments to occur in real time and for physicians and patients to access a reliable record of the medical treatment linked to the indisputable payment event.

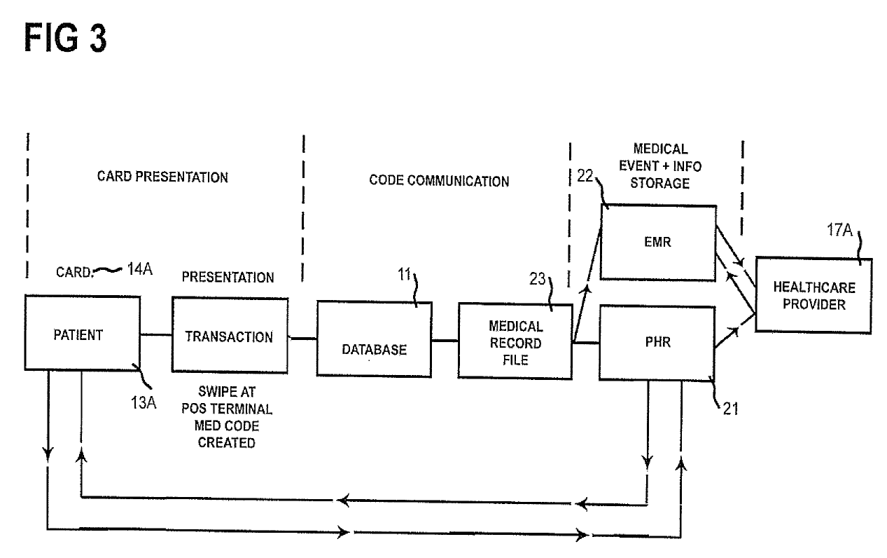

FIG. 3 represents the medical information module and how that information is created, transferred distributed and stored. Upon card presentation at the point of sale, the Healthcare Provider may choose to attach one of the medical codes 20 to the payment. Medical codes may be standard and universal as in the ICD-9 codes used world-wide, or special as in the “x-codes” used in some states to tag medical procedures. Any code can be programmed to work on the POS terminal through the addition of an application downloaded to the terminal software that reads the code. The system is therefore not restricted by the codes it may carry either by length or type and additional length or alpha-numeric configuration can be developed to create a greater amount of information regarding the event. The Healthcare Provider is prompted to make the code entry prior to the swipe of the card for payment. The bundled information is then sent to the CPC 11. The financial information is segregated from the medical information and moved to the medical record file. The file can be programmed to immediately download the information to the patient health record file (PHR) 21 or the Healthcare Provider's electronic medical record storage system 22 or both. The double flow line between the PHR and the Patient card on FIG. 1 indicates that the card can be used to access the medical information created by, and coded to the payment event. Similarly, the patient may access their PHR 21 directly to make comment or edit the information provided in accordance and compliance with national standards for electronic health care transactions also know as the Health Insurance Portability and Accountability Act (HIPAA).

This system allows the stakeholders to create, access and appropriately use actual, accurate and historical records of patient medical treatment entered into the system through the invention's closed loop method. All information is created in real time as the processing events occur. The inclusion of medical information as an adjunct of the payment transaction process assists both physician and patient in making accurate best-practice healthcare decisions.

Since various modifications can be made in the invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method for controlling the purchase of health care products and services comprising:
providing a processing center for managing communications of financial and medical data;
providing a holder of funds for payment for the health care products and services;
supplying to each of a plurality of users a card having card data thereon;
defining for the users a plurality of authorized merchants of health care products and services;
selling to each of a plurality of subscribers a health care system in which a plurality of users associated with the subscriber are provided with funds to pay for health care products and services from the plurality of authorized merchants;
each of the subscribers being arranged to place a selected amount of funds for each user associated with the subscriber in an account associated with the user held by the holder;
providing to each of the authorized merchants a conventional merchant terminal for payment of funds by credit card;
providing to each of the authorized merchants a merchant number arranged to be communicated to the ISO for payment of funds by credit card;
providing a series of codes each identifying a respective one of the health care products and services to be supplied by the plurality of authorized merchants;
in each purchase transaction, on presentation of the card by a user to pay a price for one of the health care products and services, causing the merchant terminal to communicate data to the processing center containing the price, the card data, the merchant number and the code to the processing center;
the ISO being arranged for each purchase transaction to obtain data from the holder of funds as to the availability of the necessary funds in the account of the user and to authorize payment of the price to the merchant in the event that the merchant number is authorized and the funds are sufficient to pay the price;
providing linkage to a Patient Heath Record (PHR) system for storing for each user the codes of health care products and services purchased by the user in association with the user;
and, for each purchase transaction of health care products and services purchased by the users, separating the codes, storing the codes, and distributing the codes and transaction information to those authorized and interested parties in addition to, or in association with the user at the PHR.

2. The method according to claim 1 wherein in all purchase transactions all codes are approved without analysis and the price is paid in all cases provided the funds are available to cover the price.

3. The method according to claim 1 wherein in all purchase transactions all authorized merchants are approved without analysis.

4. The method according to claim 1 wherein the codes are not stored by the processing center.

5. The method according to claim 1 wherein the PHR is accessible by the user to add user information provided by the user in addition to the codes.

6. The method according to claim 1 wherein the merchants are required to provide a discount on the price in order to be authorized.

7. The method according to claim 1 wherein the health care system is sold to subscribers by primary health care providers.

8. The method according to claim 1 wherein each card is sold to a subscriber for a set price which is added to the amount to be applied to the users account.

9. The method according to claim 1 wherein funds are held securely in trust on behalf of the owner in a financial institution in compliance with all Payment Card Industry Data Security Standards as well as all laws and regulations directed at consumer protection for the electronic transfer of funds which provide strict error resolution procedures.

10. The method according to claim 1 wherein there is a plurality of PHRs and wherein the system selects that one which is associated with the user.

11. The method according to claim 1 wherein the system is arranged to support a plurality of separate cards where each card is a proprietary card supplied by one party and is associated with a plurality of authorized merchants selected by that party.
